(19) United States
(12) Patent Application Publication
(10) Pub. No.: US 2018/0013505 A1
(43) Pub. Date: Jan. 11, 2018

(54) DATA PROCESSING DEVICE AND DATA PROCESSING METHOD

(71) Applicant: FUJITSU LIMITED, Kawasaki-shi (JP)

(72) Inventor: Ken ATSUMI, Sendai (JP)

(73) Assignee: FUJITSU LIMITED, Kawasaki-shi (JP)

(21) Appl. No.: 15/619,843

(22) Filed: Jun. 12, 2017

(30) Foreign Application Priority Data
Jul. 5, 2016 (JP) 2016-133696

(51) Int. Cl. H04J 3/06; H04J 3/16

(52) U.S. Cl. CPC H04J 3/0623; H04J 3/167; H04J 2203/0085

(57) ABSTRACT

A data processing device includes: a FIFO buffer; a write circuit writing data in the buffer according to a write clock signal; a read circuit reading data from the buffer according to a read clock signal, a PLL circuit conducting a phase synchronization processing of the read clock signal based on a phase difference between the write and read clock signals and outputting a notification signal when the phase difference becomes within a predetermined range; a write control circuit controlling a timing when the write circuit starts writing based on the notification signal; a read control circuit comparing an address in which data is written and a reference address and controlling a timing when the read circuit starts reading based on a comparison result; and a correction circuit correcting the reference address with a value corresponding to the phase difference obtained when the notification signal has been output.

### CROSS-REFERENCE TO RELATED APPLICATION

This application is based upon and claims the benefit of priority of the prior Japanese Patent Application No. 2016-133696, filed on Jul. 5, 2016, the entire contents of which are incorporated herein by reference.

### FIELD

A certain aspect of embodiments described herein relates to a data processing device and a data processing method.

### BACKGROUND

To cope with increasing demand for communications, transmission schemes using, for example, Optical Transport Network (OTN) technologies have diffused. The OTN is defined by International Telecommunication Union Telecommunication Standardization Sector (ITU-T) Recommendation G709/Y.1331.

In the OTN, client signals such as Ethernet (Registered Trademark) frames, Synchronous Optical NETwork (SONET) frames, and Synchronous Digital Hierarchy (SDH) frames are accommodated in an OTN frame and then transmitted at high speed. In the OTN transmission system, a transmission device on a transmit side executes a mapping process that accommodates client signals in an OTN frame at the transmission rate of the OTN frame, while a transmission device on a receive side executes a demapping process that separates the client signals from the OTN frame at the transmission rate of the client signal.

The OTN frame includes not only signal data of the client signal but also stuff data for adjusting the difference in transmission rate between the OTN frame and the client signal. Thus, for example, the transmission device on the receive side once writes the data of the OTN frame excluding the stuff data in a first-in first-out (FIFO) buffer according to a write clock signal corresponding to the transmission rate of the OTN frame in the demapping process. The transmission device on the receive side generates from the write clock signal a read clock signal corresponding to the transmission rate of the client signal with a phase locked loop (PLL) circuit, and then reads data from the FIFO buffer according to the read clock signal.

With the above-described processes, the transmission device on the receive side converts the data rate between the OTN frame and the client signal. For example, Japanese Patent Application Publication Nos. 1-61139 and 2007-336043 disclose techniques relating to data processing using an FIFO buffer.

### SUMMARY

According to a first aspect of the present invention, there is provided a data processing device including: a buffer from which data is read in an order that the data is written; a write circuit configured to write data in the buffer according to a write clock signal; a read circuit configured to read data from the buffer according to a read clock signal, a PLL circuit configured to conduct a phase synchronization processing of the read clock signal based on a phase difference between the write clock signal and the read clock signal, and to output a notification signal when the phase difference becomes within a predetermined range; a write control circuit configured to control a timing at which the write circuit starts writing based on the notification signal; a read control circuit configured to compare an address in which data is written by the write circuit and a reference address, and to control a timing at which the read circuit starts reading based on a comparison result; and a correction circuit configured to correct the reference address with a correction value corresponding to the phase difference that is obtained when the notification signal has been output.

According to a second aspect of the present invention, there is provided a data processing method that writes data in a buffer according to a write clock signal and reads data from the buffer according to a read clock signal in an order that the data is written, the data processing method including: conducting a phase synchronization processing of the read clock signal based on a phase difference between the write clock signal and the read clock signal; outputting a notification signal when the phase difference becomes within a predetermined range; controlling a timing for starting writing of data in the buffer based on the notification signal; comparing an address of the buffer in which data is written and a reference address; controlling a timing for starting reading of data from the buffer based on a result of the comparing; and correcting the reference address with a correction value corresponding to the phase difference that is obtained when the notification signal has been output.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an exemplary transmission system;

FIG. 2 is a configuration diagram of a data rate conversion circuit of a comparative example;

FIG. 3 is a timing diagram of the data rate conversion circuit;

FIG. 4 is a configuration diagram of a PLL circuit of the comparative example;

FIG. 5 illustrates an example of a variation in amount of data in an FIFO buffer;

FIG. 6 illustrates an exemplary relation between a variation in phase difference in the PLL circuit of the comparative example and the amount of data in the FIFO buffer;

FIG. 7 illustrates an example of phase fluctuation of a read clock signal;

FIG. 8 illustrates examples of margins for overflow and underflow in accordance with a position around which the amount of data in the FIFO buffer fluctuates;

FIG. 9 is a configuration diagram of a data rate conversion circuit of an embodiment;

FIG. 10 is a configuration diagram of a PLL circuit of the embodiment;

FIG. 11 is a configuration diagram of an exemplary address correction circuit;

FIG. 12 is a flowchart illustrating exemplary operations of the data rate conversion circuit;

FIG. 13 is a timing diagram illustrating exemplary operations of the data rate conversion circuit; and

FIG. 14 illustrates an exemplary relation between the variation in phase difference in the PLL circuit of the embodiment and the amount of data in the FIFO buffer.

### DESCRIPTION OF EMBODIMENTS

At start-up or reset of the transmission device, writing of data in the FIFO buffer and reading of data from the FIFO buffer are started when the PLL circuit establishes the phase synchronization of the read clock signal. After the writing of data in the FIFO buffer starts, the reading of data from the FIFO buffer starts when the amount of data that has been written in the FIFO buffer reaches, for example, half of the memory capacity of the FIFO buffer.

Accordingly, the difference between a write object address and a read object address in the address space of the FIFO buffer is maximized. Therefore, the occurrence of overflow or underflow of the FIFO buffer is effectively prevented. The above-described operation is called, for example, “FIFO centering”.

After the phase synchronization is established, the phase of the read clock signal fluctuates due to the low response performance of the PLL circuit and eventually converges, while the amount of data in the FIFO buffer fluctuates in accordance with the phase fluctuation of the read clock signal. For example, as the amount of delay of the phase of the read clock signal increases, the amount of data increases, while the amount of data decreases as the amount of delay of the phase of the read clock signal decreases.

Thus, if the FIFO centering is conducted when the phase difference between the write clock signal and the read clock signal at the time of the establishment of phase synchronization deviates from the value to which the phase fluctuation of the read clock signal converges, the amount of data in the FIFO buffer deviates from half of the storage capacity of the FIFO buffer when the phase fluctuation converges. In this case, an effective margin for overflow or underflow is not secured in the FIFO buffer.

The margin effective for overflow or underflow can be secured by increasing the storage capacity of the FIFO buffer. In this case, however, in addition to the increase in device cost, latency of communication increases and thereby, the communication performance decreases because the time it takes to read data from the FIFO buffer after the data is written therein increases.

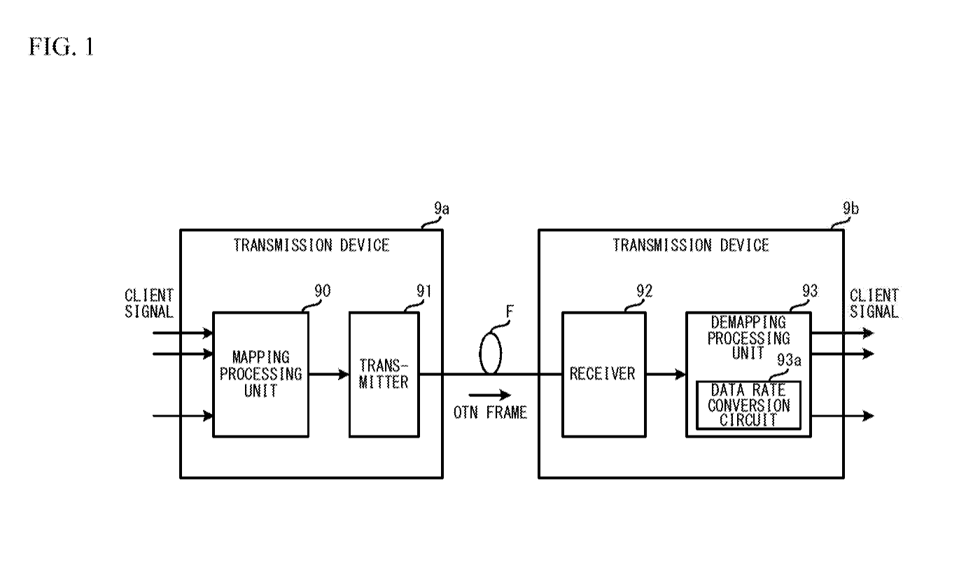

FIG. 1 is a configuration diagram of an exemplary transmission system. The transmission system uses a transmission scheme based on, for example, the OTN technology. The transmission system includes a transmit-side transmission device 9a and a receive-side transmission device 9b, which are coupled via a transmission line F.

The transmit-side transmission device 9a includes a mapping processing unit 90 and a transmitter 91. The mapping processing unit 90 accommodates a plurality of client signals input from other devices in an OTN frame, which is an example of a frame signal. That is, the mapping processing unit 90 conducts a mapping process of the OTN frame. The mapping process is conducted at the transmission rate of the OTN frame on the transmission line F. Examples of the client signals include, but are not limited to, Ethernet frames, SDH frames, and SONET frames.

The transmitter 91 includes, for example, a modulator and a laser diode. The transmitter 91 modulates the OTN frame accommodating the client signals, and converts the modulated OTN frame in light, which is then transmitted to the transmission line F. The transmission line F is, for example, an optical fiber, and is coupled to the receive-side transmission device 9b.

The receive-side transmission device 9b includes a receiver 92 and a demapping processing unit 93. The receiver 92 includes, for example, a demodulator and a photodiode. The receiver 92 receives the OTN frame, converts the received OTN frame in the electric version, and demodulates the resultant OTN frame. The demapping processing unit 93 separates the plurality of client signals from the demodulated OTN frame, and outputs them to other devices. That is, the demapping processing unit 93 conducts a demapping process of the OTN frame. The mapping processing unit 90 and the demapping processing unit 93 are composed of hardware such as an integrated circuit, or composed of hardware and a processor that conducts a control process by software.

The demapping processing unit 93 extracts client signals from the OTN frame at the transmission rates of the individual client signals at which the individual client signals were input to the transmit-side transmission device 9a. Thus, the demapping processing unit 93 includes a data rate conversion circuit 93a that converts the data rate of the signal data of the OTN frame. The data rate conversion circuit 93a is an example of a signal processing device that conducts a signal processing method of the embodiment, and converts the data rate from the transmission rate of the OTN frame into the transmission rate of each client signal.

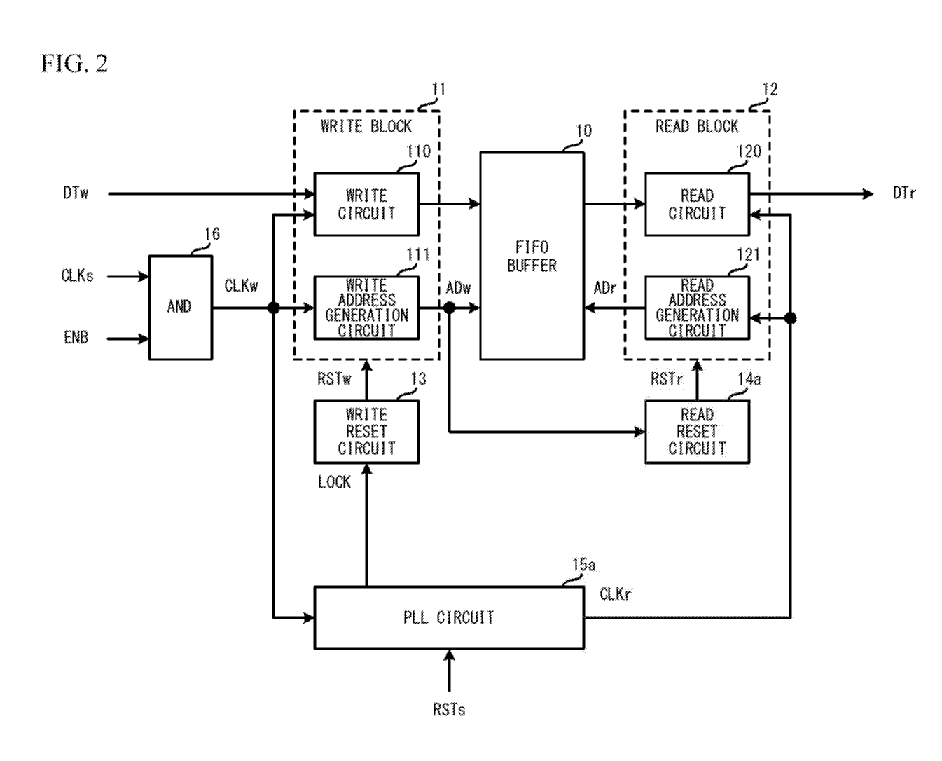

FIG. 2 is a configuration diagram of the data rate conversion circuit 93a of a comparative example. The data rate conversion circuit 93a includes a FIFO buffer 10, a write block 11, a read block 12, a write reset circuit 13, a read reset circuit 14a, a PLL circuit 15a, and an AND gate 16.

The write block 11 includes a write circuit 110 and a write address generation circuit 111. The write circuit 110 writes signal data DTw of the OTN frame in the FIFO buffer 10 according to a write clock signal CLKw. The FIFO buffer 10 is an example of a buffer. Data is read from the FIFO buffer 10 in the order that the data was written. The write address generation circuit 111 generates an address (hereinafter, referred to as a “write address”) ADw in the FIFO buffer 10 in which the write circuit 110 is to write data according to the write clock signal CLKw.

The read block 12 includes a read circuit 120 and a read address generation circuit 121. The read circuit 120 reads signal data DTr from the FIFO buffer 10 according to a read clock signal CLKr. The read address generation circuit 121 generates an address (hereinafter, referred to as a “read address”) ADr indicating the location of the signal data DTr to be read from the FIFO buffer 10 according to the read clock signal CLKr.

The OTN frame contains not only signal data of the client signal but also stuff data for adjusting the difference in transmission rate between the OTN frame and the client signal. Thus, the write circuit 110 writes signal data excluding the stuff data from the data of the OTN frame in the FIFO buffer 10. More specifically, the write circuit 110 removes the stuff data from the signal data DTw of the OTN frame according to the write clock signal CLKw.

The write clock signal CLKw is generated from an input clock signal CLKs and an enable signal ENB by the AND gate 16. The input clock signal CLKs is in synchronization with the signal data DTw of the OTN frame, and is extracted from the OTN frame prior to the data rate conversion circuit. The enable signal ENB is generated based on a frame synchronization processing of the OTN frame prior to the data rate conversion circuit. The voltage level of the enable signal ENB exhibits a low level during the duration corresponding to the stuff data of the signal data DTw, and exhibits a high level during the duration corresponding to the remaining signal data.

The AND gate 16 calculates the logical AND of the input clock signal CLKs and the enable signal ENB, and outputs the write clock signal CLKw as the calculation result. Thus, the write clock signal CLKw is a pulse signal in which pulses corresponding to the stuff data are excluded from the pulses of the input clock signal CLKs like missing tooth. This duration with no pulse corresponds to the difference in transmission rate between the OTN frame and the client signal.

Therefore, the write circuit 110 can extract the signal data excluding the stuff data from the signal data DTw and write the extracted signal data in the FIFO buffer 10 according to the write clock signal CLKw. Accordingly, only the signal data of the client signal in the signal data DTw of the OTN frame is written in the FIFO buffer 10. The write clock signal CLKw is output to the write circuit 110, the write address generation circuit 111, and the PLL circuit 15a.

The PLL circuit 15a generates the read clock signal CLKr from the write clock signal CLKw by conducting a phase synchronization processing. The PLL circuit 15a generates the read clock signal CLKr having a fixed period by averaging the pulses of the write clock signal CLKw having the duration with no pulse on the time axis. The read clock signal CLKr is output to the read circuit 120 and the read address generation circuit 121.

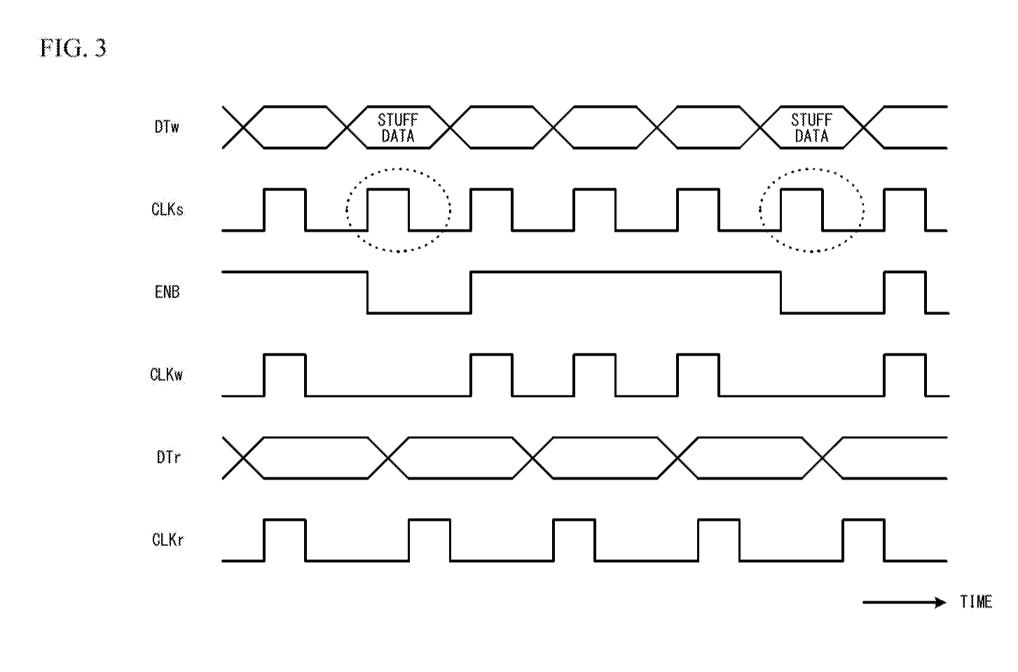

FIG. 3 is a timing diagram of the data rate conversion circuit. As described above, since the write clock signal CLKw is the logical AND of the input clock signal CLKs and the enable signal ENB, the write clock signal CLKw becomes a pulse signal in which pulses during the duration corresponding to the stuff data (see dotted circles) of the input clock signal CLKs are removed in the signal data DTw like missing tooth. Thus, the signal data DTw from which the stuff data is excluded is written in the FIFO buffer 10.

The signal data DTw written in the FIFO buffer 10 is read as the signal data DTr according to the clock signal CLKr. The read clock signal CLKr corresponds to the transmission rate at which the client signal was input to the transmit-side transmission device 9a. As described above, the data rate conversion circuit 93a converts the data rate by once writing the signal data DTw of the OTN frame in the FIFO buffer 10.

With reference to FIG. 2 again, the PLL circuit 15a starts operating in response to a device reset signal RSTs. The PLL circuit 15a conducts the phase synchronization processing of the read clock signal CLKr with the write clock signal CLKw, and outputs a synchronization detection signal LOCK when detecting the establishment of the phase synchronization. More specifically, the PLL circuit 15a outputs the synchronization detection signal LOCK when the phase difference of the read clock signal CLKr from the write clock signal CLKw becomes within a predetermined range. The synchronization detection signal LOCK is an example of a notification signal that reports the establishment of the phase synchronization.

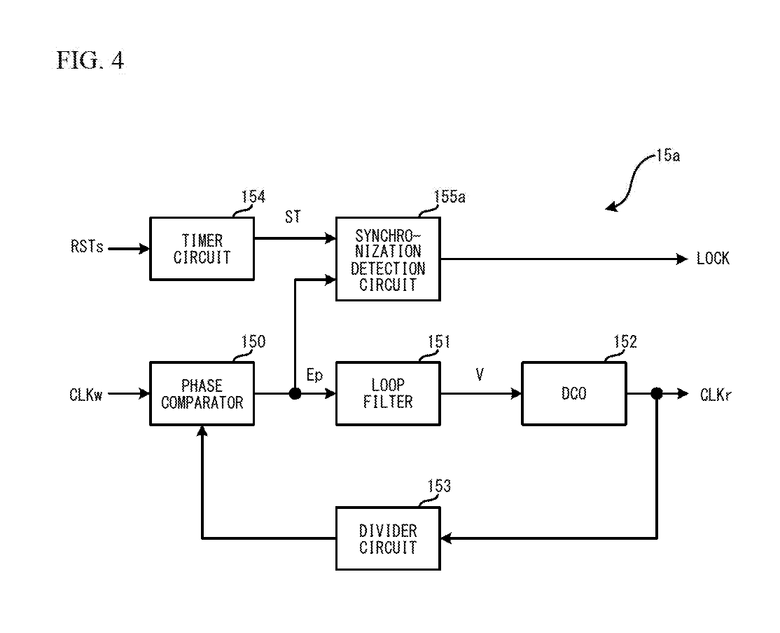

FIG. 4 is a configuration diagram of the PLL circuit 15a of the comparative example. The PLL circuit 15a includes a phase comparator 150, a loop filter 151, a digital controlled oscillator (DCO) 152, a divider circuit 153, a timer circuit 154, and a synchronization detection circuit 155a.

The PLL circuit 15a outputs from the DCO 152 the read clock signal CLKr of which the phase has been synchronized with that of the write clock signal CLKw by feedback control. The divider circuit 153 divides the read clock signal CLKr. The divided read clock signal CLKr is input to the phase comparator 150s.

The phase comparator 150 detects a phase difference Ep between the write clock signal CLKw and the read clock signal CLKr output from the DCO 152. More specifically, the phase comparator 150 detects the phase difference between the write clock signal CLKw and the read clock signal CLKr divided by the divider circuit 153. The phase comparator 150 outputs a differential signal indicating the phase difference Ep to the loop filter 151 and the synchronization detection circuit 155a.

The loop filter 151 generates a control signal V by filtering the differential signal input from the phase comparator 150. Examples of the loop filter 151 include, but are not limited to, an infinite impulse response (IIR) filter or other digital filters. The generated control signal V is input to the DCO 152.

The DCO 152 outputs the read clock signal CLKr with a frequency corresponding to the voltage of the control signal V input from the loop filter 151. That is, the DCO 152 controls the frequency of the read clock signal CLKr based on the control signal V.

The read clock signal CLKr is fed back to the phase comparator 150 through the divider circuit 153. The divider circuit 153 divides the read clock signal CLKr, and then outputs the resultant read clock signal CLKr to the phase comparator 150. The divider circuit 153 performs frequency dividing with, for example, a counter circuit.

The timer circuit 154 starts counting time when the device reset signal RSTs is input. More specifically, the timer circuit 154 starts a timer when the voltage level of the device reset signal RSTs varies from the low level to the high level. The timer circuit 154 outputs an operation instruction signal ST to the synchronization detection circuit 155a when the timer expires.

The synchronization detection circuit 155a starts detecting the phase synchronization according to the operation instruction signal ST. More specifically, the synchronization detection circuit 155a starts operating when the voltage level of the operation instruction signal ST varies from the low level to the high level.

The synchronization detection circuit 155a determines whether the phase difference Ep detected by the phase comparator 150 has become within a predetermined range during a transient state until the read clock signal CLKr output from the PLL circuit 15a becomes stable. The synchronization detection circuit 155a considers that the phase synchronization of the read clock signal CLKr with the write clock signal CLKw has been established when the phase difference Ep becomes within the predetermine range, and outputs the synchronization detection signal LOCK.

As described above, the PLL circuit 15a conducts the phase synchronization processing of the read clock signal CLKr based on the phase difference Ep, and outputs the synchronization detection signal LOCK when the phase difference Ep becomes within the predetermined range. The synchronization detection signal LOCK is output to the write reset circuit 13. Therefore, the PLL circuit 15a synchronizes the phase of the read clock signal CLKr with that of the write clock signal CLKw, and starts the writing in the FIFO buffer 10 and the reading from the FIFO buffer 10 when the phase synchronization is established as described below.

Turning back to FIG. 2 again, the write reset circuit 13 is an example of a write control circuit, and controls the timing at which the write circuit 110 starts writing based on the synchronization detection signal LOCK. More specifically, the write reset circuit 13 releases the reset state of the write block 11 by varying the voltage level of the write reset signal RSTw, which is output to the write block 11, from the low level to the high level when the synchronization detection signal LOCK is input.

When the write block 11 is released from the reset state, the write circuit 110 starts writing the signal data DTw in the FIFO buffer 10 according to the write clock signal CLKw. Thus, the write circuit 110 can start the writing in the FIFO buffer 10 after the phase synchronization of the read clock signal CLKr is established. The write circuit 110 writes the signal data DTw at the rise of the write clock signal CLKw. The data already written in the FIFO buffer 10 is cleared by resetting the write block 11.

Additionally, when the write block 11 is released from the reset state, the write address generation circuit 111 starts generating the write address ADw of the FIFO buffer 10 according to the write clock signal CLKw. The write address generation circuit 111 increments the write address ADw from a predetermined initial value every time the write clock signal CLKw rises. The write address ADw returns to the initial value after reaching the maximum value of the address of the FIFO buffer 10.

The read reset circuit 14a monitors the write address ADw, and releases the read block 12 from the reset state when the write address ADw reaches the address corresponding to the position of the half of the storage capacity in the address space of the FIFO buffer 10. More specifically, the read reset circuit 14a varies the voltage level of the read reset signal RSTr, which is output to the read block 12, from the low level to the high level.

This operation releases the read block 12 from the reset state when the amount of data that has been written in the FIFO buffer 10 reaches half of the entire capacity. When the read block 12 is released from the reset state, the read circuit 120 starts reading the signal data DTr from the FIFO buffer 10. The read circuit 120 reads the signal data DTr at the rise of the read clock signal CLKr.

Additionally, when the read block 12 is released from the reset state, the read address generation circuit 121 starts generating the read address ADr according to the read clock signal CLKr. The read address generation circuit 121 increments the read address ADr from a predetermined initial value every time the read clock signal CLKr rises. The read address ADr returns to the initial value after reaching the maximum value of the address of the FIFO buffer 10.

As described above, at start-up or reset of the transmission device 9b, the writing of data in the FIFO buffer 10 and the reading of data from the FIFO buffer 10 are started when the phase synchronization of the read clock signal CLKr is established by the PLL circuit 15a. When the amount of data that has been written in the FIFO buffer 10 after the start of the wiring of data in the FIFO buffer 10 reaches half of the storage capacity of the FIFO buffer 10, the reading of data from the FIFO buffer 10 is started.

Thus, the difference between the write address ADw and the read address ADr is maximized in the address space of the FIFO buffer 10. Therefore, the overflow and underflow of the FIFO buffer 10 are effectively prevented.

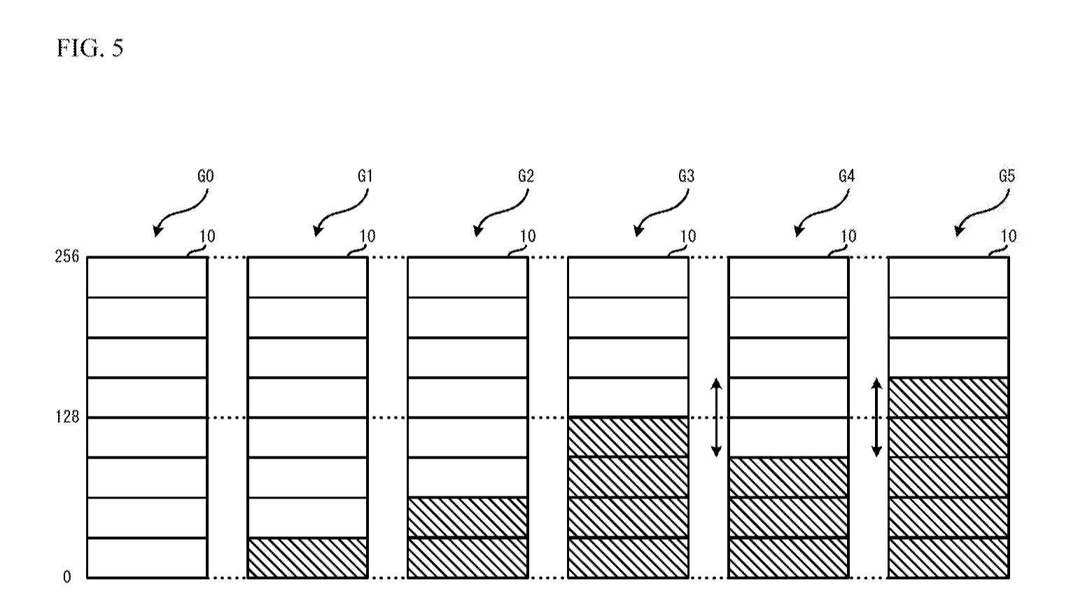

FIG. 5 illustrates an example of a variation in the amount of data in the FIFO buffer 10. In the present example, the storage capacity of the FIFO buffer 10 is specified to be 256 (arbitrary unit), and the same applies to the description hereinafter. Areas indicated with hatched lines represent areas in which data are already stored among the memory areas of the FIFO buffer 10.

Referential mark G0 represents the initial state of the FIFO buffer 10 when the transmission device 9b is started or reset. The data (signal data DTw) in the FIFO buffer 10 is cleared by the write reset signal RSTw.

When the writing of data in the FIFO buffer 10 is started, the amount of data in the FIFO buffer 10 increases with time by a predetermined value as indicated by referential marks G1 through G3. As indicated by referential mark G3, when the amount of data in the FIFO buffer 10 reaches half of the storage capacity of the FIFO buffer 10, i.e., 128 (=256÷2), the reading of data from the FIFO buffer 10 is started.

Thereafter, the amount of data in the FIFO buffer 10 fluctuates around the half of the storage capacity of the FIFO buffer 10 in accordance with the fluctuation of the input clock signal CLKs as indicated by referential marks G4 and G5. In the above operation, since the center of the fluctuation corresponds to the half of the storage capacity, the difference between the write address ADw and the read address ADr is maximized in the address space of the FIFO buffer 10, and the occurrence of the overflow or underflow of the FIFO buffer 10 is therefore prevented.

However, this FIFO centering method may fail to achieve the above-described effect depending on the phase difference Ep at the time of establishment of the phase synchronization in the PLL circuit 15a.

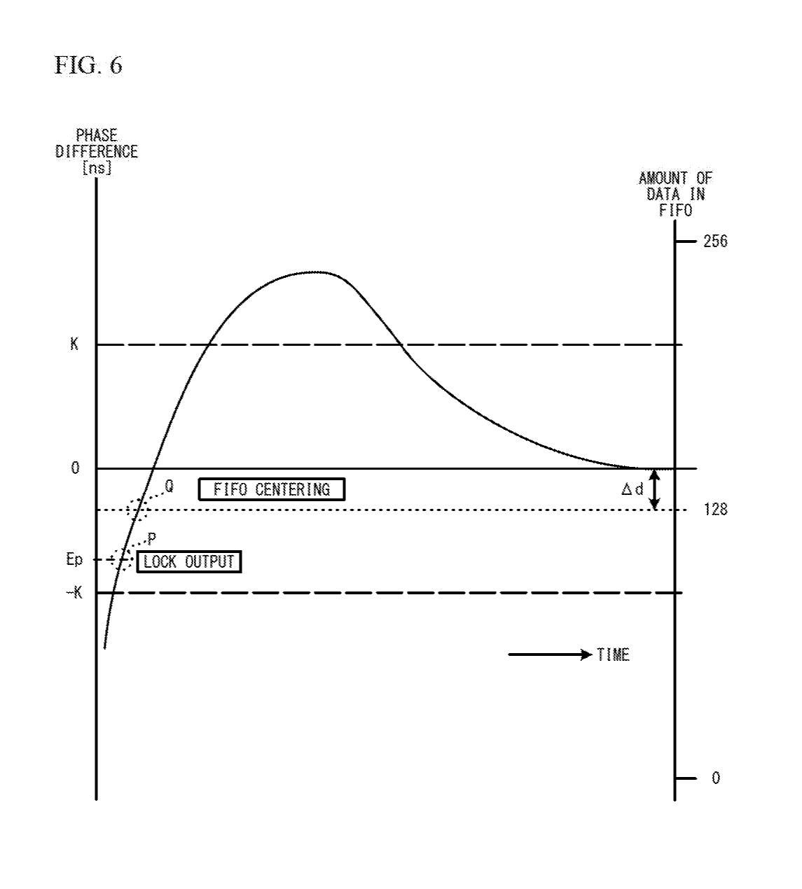

FIG. 6 illustrates an exemplary relation between variation in the phase difference Ep in the PLL circuit 15a of the comparative example and the amount of data in the FIFO buffer 10. In FIG. 6, the horizontal axis represents time, and the vertical axes represent the phase difference Ep (ns) and the amount of data in the FIFO buffer 10.

The synchronization detection circuit 155a starts detecting the phase synchronization after the timer of the timer circuit 154 expires. The synchronization detection circuit 155a outputs the synchronization detection signal LOCK when the phase difference Ep meets the condition of, for example, −K≦Ep≦K (K>0), i.e., the condition of |Ep|≦K as indicated by referential mark P.

The phase of the read clock signal CLKr fluctuates due to the slow response performance of the PLL circuit 15a and eventually converges after the establishment of the phase synchronization, while the amount of data in the FIFO buffer 10 fluctuates in accordance with the fluctuation of the phase of the read clock signal CLKr. For example, as the delay amount of the phase of the read clock signal CLKr increases, the amount of data increases, while the amount of data decreases as the delay amount of the phase of the read clock signal CLKr decreases.

Thus, when the phase difference Ep at the time of output of the synchronization detection signal LOCK deviates from the value to which the phase fluctuation of the read clock signal CLKr converges, the execution of the FIFO centering indicated by referential mark Q results in a deviation of the amount of data from the half of the storage capacity of the FIFO buffer 10 when its phase fluctuation converges. That is, even if the amount of data in the FIFO buffer 10 at the time of the FIFO centering is 128, the amount of data in the FIFO buffer 10 deviates from 128 by a deviation Δd after the fluctuation of the read clock signal CLKr converges.

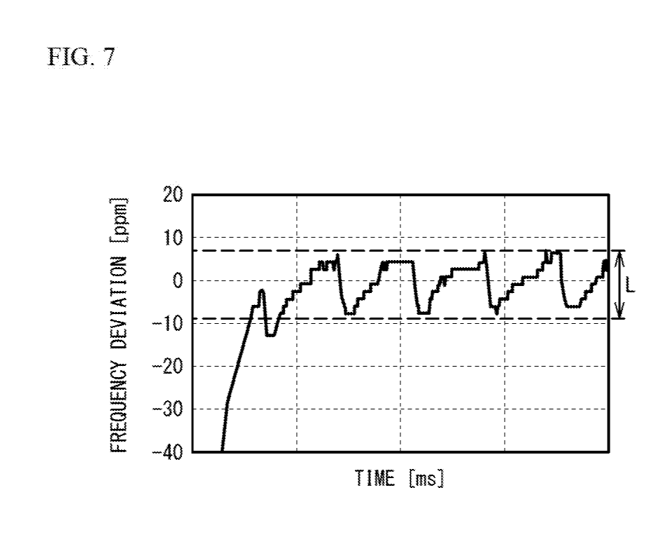

FIG. 7 illustrates an example of the phase fluctuation of the read clock signal CLKr. In FIG. 7, the horizontal axis represents time (ms), while the vertical axis represents the frequency deviation (ppm) of the read clock signal CLKr. Referential mark L indicates a fluctuation range in which the synchronization detection signal LOCK is output from the synchronization detection circuit 155a.

The write clock signal CLKw input to the PLL circuit 15a is a pulse signal having the duration with no pulse as described above. Thus, the frequency deviation of the read clock signal CLKr is not maintained at the center value 0 and continues to fluctuate after converging into the range L. Therefore, when the FIFO centering is conducted in response to the synchronization detection signal LOCK, the frequency deviation at the time of the FIFO centering may deviate from the center value 0 depending on its timing.

Accordingly, the amount of data after the convergence of the fluctuation of the read clock signal CLKr deviates from half of the storage capacity of the FIFO buffer 10. In this case, the margin for the overflow or underflow of the FIFO buffer 10 decreases.

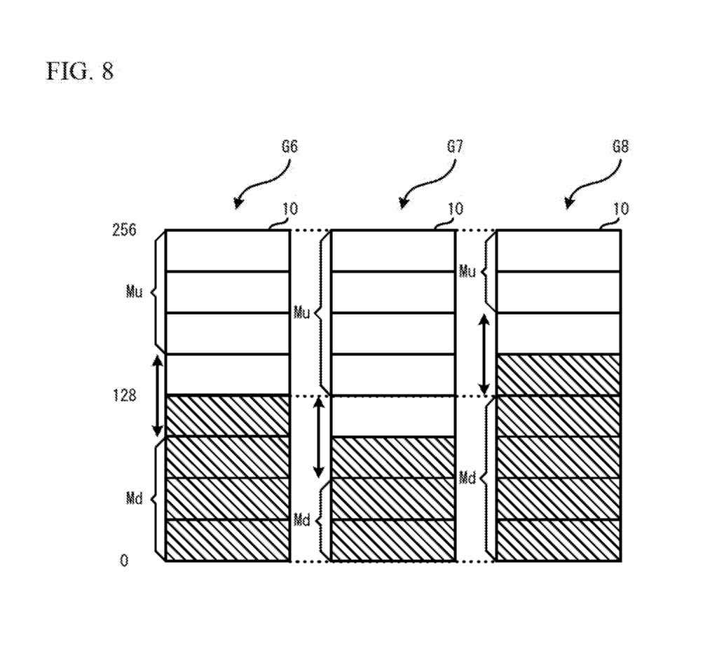

FIG. 8 illustrates an example of margins for overflow and underflow in accordance with a position around which the amount of data in the FIFO buffer 10 fluctuates. In FIG. 8, arrows indicate examples of the range within which the amount of data fluctuates. Referential mark Mu indicates the margin for overflow, and referential mark Md indicates the margin for underflow. Areas indicated with hatched lines represent areas in which data are already stored among the memory areas of the FIFO buffer.

Referential mark G6 indicates a case where the amount of data after the convergence of the fluctuation of the read clock signal CLKr does not deviate. In this case, the amount of data fluctuates around the half of the storage capacity of the FIFO buffer 10 (i.e., 128) in accordance with the fluctuation of the input clock signal CLKs. Thus, the sufficient margins Mu and Md for overflow and underflow are secured.

Referential mark G7 indicates a case where the amount of data after the convergence of the fluctuation of the read clock signal CLKr is below the half of the storage capacity of the FIFO buffer 10. In this case, the amount of data fluctuates around a value less than the half of the storage capacity of the FIFO buffer 10 (i.e., the value less than 128) in accordance with the fluctuation of the input clock signal CLKs. Thus, compared to the case indicated by referential mark G6, the margin Mu for overflow increases, but the margin Md for underflow decreases.

Referential mark G8 indicates a case where the amount of data after the convergence of the fluctuation of the read clock signal CLKr is greater than the half of the storage capacity of the FIFO buffer 10. In this case, the amount of data fluctuates around a value greater than the half of the storage capacity of the FIFO buffer 10 (i.e., the value greater than 128) in accordance with the fluctuation of the input clock signal CLKs. Thus, compared to the case indicated by referential mark G6, the margin Md for underflow increases, but the margin Mu for overflow decreases.

As described above, in the cases indicated by referential marks G7 and G8, an effective margin for overflow or underflow is not secured in the FIFO buffer. The effective margin for overflow or underflow can be secured by, for example, increasing the storage capacity of the FIFO buffer 10. However, this countermeasure arises not only a problem that the device cost increases but also another problem that communication latency increases and the communication performance thereby decreases because the time it takes to read data from the FIFO buffer 10 after the data is written therein increases.

Thus, an embodiment corrects the address to be subject to the FIFO centering in accordance with the phase difference Ep at the time of the establishment of the phase synchronization to reduce the deviation of the amount of data after the convergence of the fluctuation of the read clock signal CLKr, thus improving the communication performance.

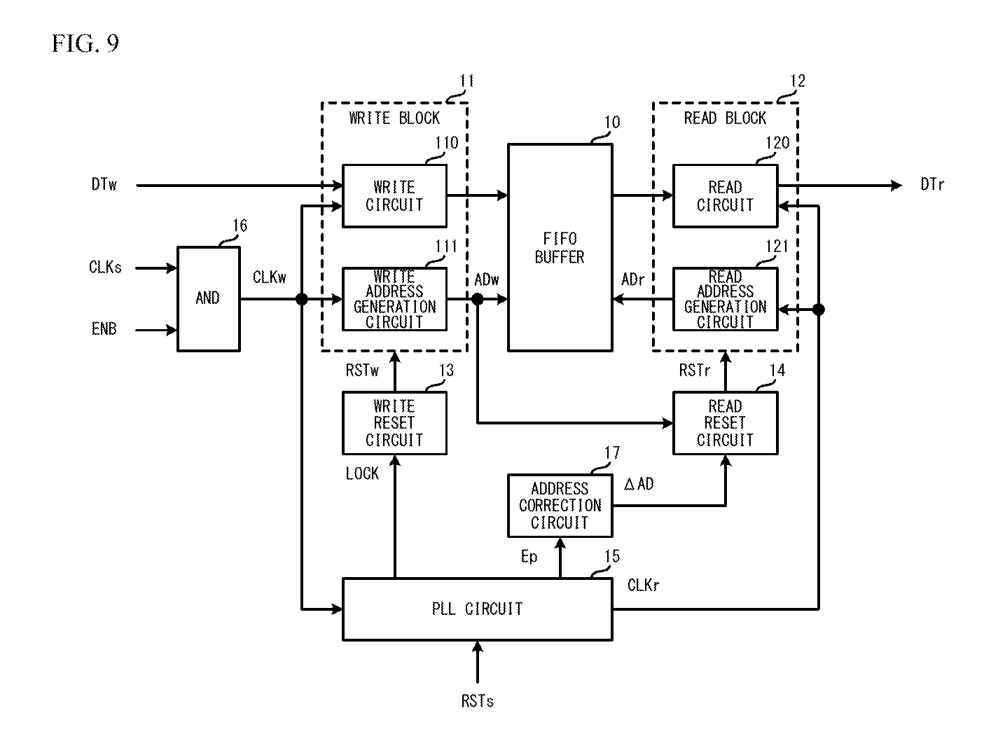

FIG. 9 is a configuration diagram of the data rate conversion circuit 93a of the embodiment. In FIG. 9, the same reference numerals are given to the components that are the same as or similar to those in FIG. 2, and the description thereof will be omitted.

The data rate conversion circuit 93a includes the FIFO buffer 10, the write block 11, the read block 12, the write reset circuit 13, a read reset circuit 14, a PLL circuit 15, the AND gate 16, and an address correction circuit 17.

As in the comparative example, the PLL circuit 15 conducts the phase synchronization processing of the read clock signal CLKr based on the phase difference Ep between the write clock signal CLKw and the read clock signal CLKr, and outputs the synchronization detection signal LOCK when the phase difference Ep becomes within the predetermined range. In the above operation, unlike the comparative example, the PLL circuit 15 outputs to the address correction circuit 17 the phase difference Ep together with the synchronization detection signal LOCK.

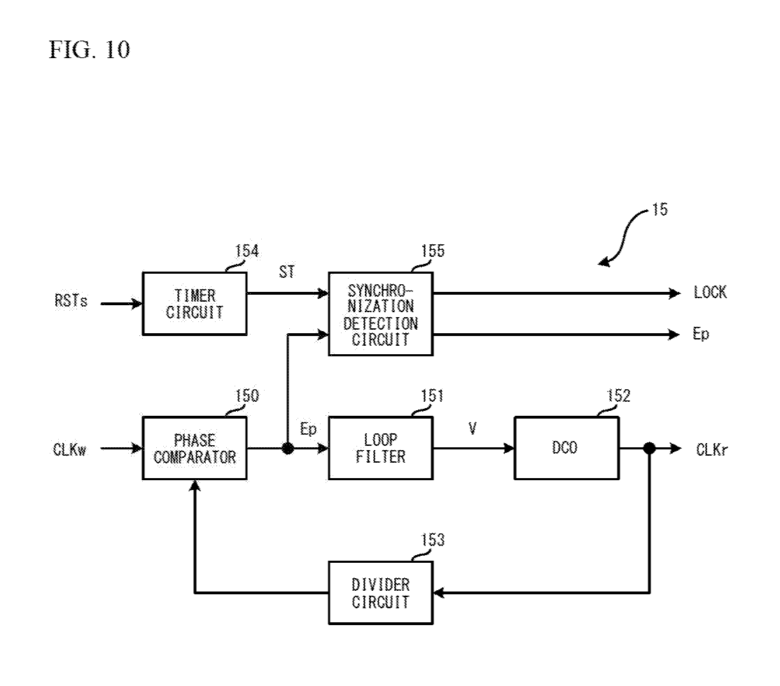

FIG. 10 is a configuration diagram of the PLL circuit 15 of the embodiment. In FIG. 10, the same reference numerals are given to the components that are the same as or similar to those in FIG. 4, and the description thereof will be omitted. The PLL circuit 15 includes the phase comparator 150, the loop filter 151, the DCO 152, the divider circuit 153, the timer circuit 154, and a synchronization detection circuit 155.

As in the comparative example, the synchronization detection circuit 155 outputs the synchronization detection signal LOCK. That is, the synchronization detection circuit 155 starts operating when the voltage level of the operation instruction signal ST varies from the low level to the high level. When the phase difference Ep becomes within the predetermined range, the synchronization detection circuit 155 considers that the phase synchronization of the read clock signal CLKr with the write clock signal CLKw has been established, and outputs the synchronization detection signal LOCK.

In the above operation, unlike the comparative example, the synchronization detection circuit 155 outputs the phase difference Ep together with the synchronization detection signal LOCK.

With reference back to FIG. 9, the read reset circuit 14 is an example of a read control circuit, and compares the write address ADw and a reference address ADs to control the timing at which the read circuit 120 starts reading based on the comparison result. More specifically, the read reset circuit 14 releases the reset state of the read block 12 by varying the voltage level of the read reset signal RSTr from the low level to the high level when the write address ADw output from the write address generation circuit 111 reaches the reference address ADs. This process increases the distance between the read address ADr and the write address ADw depending on the reference address ADs.

The address correction circuit 17 is an example of a correction circuit, and corrects the reference address ADs based on a correction value ΔAD corresponding to the phase difference Ep that was obtained when the synchronization detection signal LOCK was output. Here, the reference address ADs is an address to be subject to the FIFO centering.

More specifically, the address correction circuit 17 generates the correction value ΔAD and outputs the generated correction value ΔAD to the read reset circuit 14 based on the phase difference Ep input from the PLL circuit 15 so that the deviation Δd (see FIG. 6) of the amount of data in the FIFO buffer 10 at the time of the convergence of the read clock signal CLKr decreases. The read reset circuit 14 adds the correction value ΔAD, which has been input, to the reference address ADs.

The address correction circuit 17 corrects the reference address ADs with the correction value ΔAD that takes into account the deviation Δd of the amount of data based on the phase difference Ep at the time of the output of the synchronization detection signal LOCK. Thus, the amount of data in the FIFO buffer 10 that is obtained when the read clock signal CLKr converges is shifted by the difference (i.e., Δd) in the amount of data corresponding to the correction value ΔAD, and becomes a desired value.

The reference address ADs before corrected, i.e., the initial value of the reference address ADs may be set to, for example, the address corresponding to the position corresponding to half of the storage capacity in the address space of the FIFO buffer 10 as in the above-described comparative example. In this case, the amount of data in the FIFO buffer 10 at the time of the convergence of the read clock signal CLKr is made half of the storage capacity of the FIFO buffer 10 by the correction with the correction value ΔAD.

Thus, as described above, since the difference between the write address ADw and the read address ADr is maximized in the address space of the FIFO buffer 10, the overflow and underflow of the FIFO buffer 10 are effectively prevented.

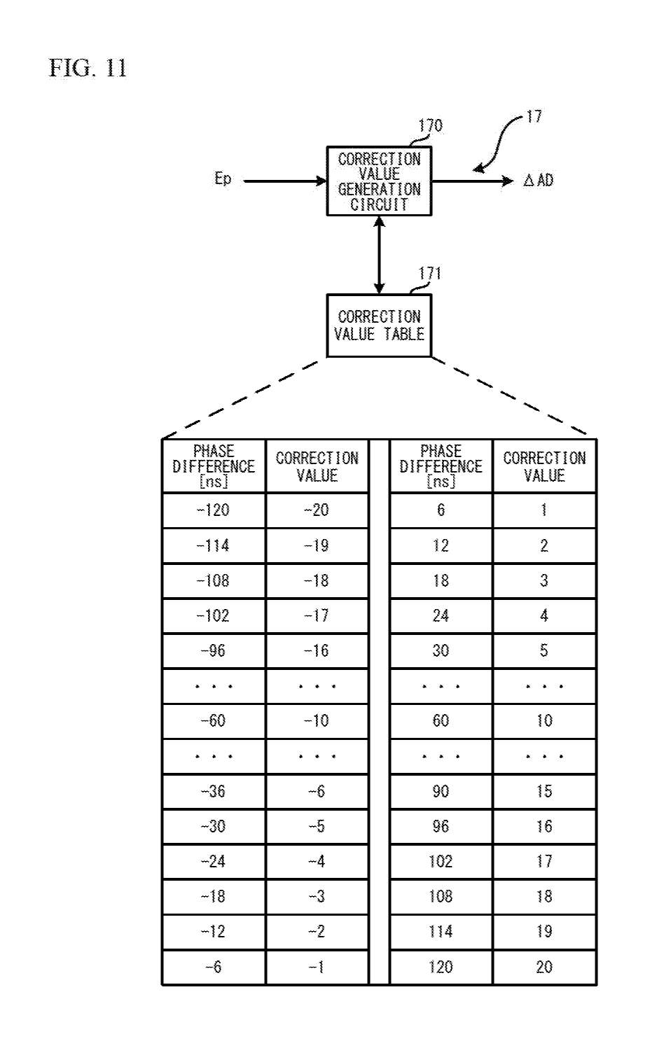

FIG. 11 is a configuration diagram of the address correction circuit 17. The address correction circuit 17 includes a correction value generation circuit 170 and a correction value table 171. The correction value table 171 is stored in a storage unit such as a memory. In the correction value table 171, relations between the phase difference Ep (ns) and the correction value ΔAD are registered.

The correction value generation circuit 170 obtains from the correction value table 171 the correction value ΔAD corresponding to the phase difference Ep input from the PLL circuit 15. More specifically, the correction value generation circuit 170 retrieves the correction value ΔAD corresponding to the phase difference Ep from the correction value table 171. The correction value table 171 is an example of a table, and the contents stored therein can be obtained from the results of simulations or experiments.

In the case of the phase difference Ep<0, i.e., when the phase of the write clock signal CLKw lags behind the phase of the read clock signal CLKr, the correction value ΔAD takes a negative value. Thus, the reference address ADs becomes smaller than its initial value ADi (ADs=ADi+ΔAD<ADi), and the amount of data in the FIFO buffer 10 at the time of the FIFO centering becomes less than the target value (e.g., the value corresponding to half of the storage capacity). Accordingly, after the convergence of the read clock signal CLKr, the amount of data in the FIFO buffer 10 is shifted to a greater value, and the amount of data in the FIFO buffer 10 therefore becomes the target value.

On the other hand, in the case of the phase difference Ep>0, i.e., when the phase of the read clock signal CLKr lags behind the phase of the write clock signal CLKw, the correction value ΔAD takes a positive value. Thus, the reference address ADs becomes greater than its initial value ADi (ADs=ADi+ΔAD>ADi), and the amount of data in the FIFO buffer 10 at the time of the FIFO centering becomes greater than the target value. Accordingly, after the convergence of the read clock signal CLKr, the amount of data in the FIFO buffer 10 is shifted to a less value, and the amount of data in the FIFO buffer 10 therefore becomes the target value.

As described above, since the address correction circuit 17 obtains from the correction value table 171 the correction value ΔAD corresponding to the phase difference Ep, the address correction circuit 17 can easily obtain the correction value ΔAD. The address correction circuit 17 may generate the correction value ΔAD by, for example, arithmetic processing by a computing circuit instead of the search for the correction value table 171.

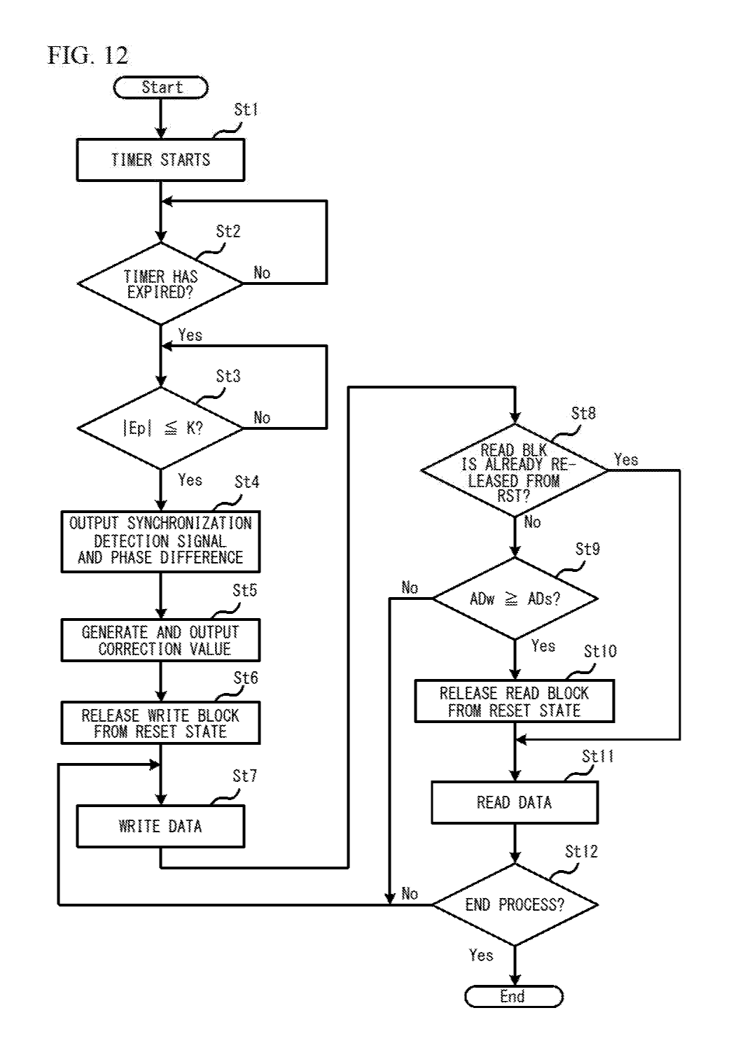

FIG. 12 is a flowchart illustrating exemplary operations of the data rate conversion circuit 93a. These operations are executed after the device reset signal RSTs releases the reset state.

The timer circuit 154 starts a timer when the voltage level of the device reset signal RSTs varies from the low level to the high level (step St1). Next, the timer circuit 154 determines whether the timer has expired (step St2). When the timer circuit 154 does not expire (No/step St2), the process of step St2 is executed again. The expiration value of the timer may be, for example, 10 (ms).

When the timer expires (Yes/step St2), the synchronization detection circuit 155 determines whether the magnitude (the absolute value) of the phase difference Ep is equal to or less than a predetermined value K (step St3). That is, the synchronization detection circuit 155 determines the establishment of the phase synchronization by detecting whether the phase difference Ep has become within the predetermined range. When the magnitude of the phase difference Ep is greater than the predetermined value K (No/step St3), the synchronization detection circuit 155 executes the process of step St3 again.

When the magnitude of the phase difference Ep is equal to or less than the predetermined value K (Yes/step St3), the synchronization detection circuit 155 determines that the phase synchronization has been established and outputs the synchronization detection signal LOCK and the phase difference Ep (step St4). In the above operation, the phase difference Ep is the value that was obtained when the synchronization detection signal LOCK was output, i.e., the value that was obtained when the establishment of the phase synchronization was determined. This step causes the PLL circuit 15 to conduct the phase synchronization processing of the read clock signal CLKr based on the phase difference Ep, and to output the synchronization detection signal LOCK when the phase difference Ep becomes within the predetermined value.

Next, the address correction circuit 17 generates the correction value ΔAD based on the phase difference Ep, and outputs the generated correction value ΔAD to the read reset circuit 14 (step St5). That is, the address correction circuit 17 converts the phase difference Ep into the correction value ΔAD. In the above operation, the read reset circuit 14 corrects the reference address ADs with the correction value ΔAD. Accordingly, the reference address ADs becomes the sum of its initial value ADi and the correction value ΔAD. As described above, the address correction circuit 17 corrects the reference address ADs with the correction value ΔAD corresponding to the phase difference Ep that was obtained when the synchronization detection signal LOCK was output.

The write reset circuit 13 releases the write block 11 from the reset state in response to the input of the synchronization detection signal LOCK (step St6). The reset state may be released at the same time as the input of the synchronization detection signal LOCK, or may be released when a predetermined time elapses after the input of the synchronization detection signal LOCK. Accordingly, the write reset circuit 13 controls the timing for starting the writing of the signal data DTw in the FIFO buffer 10 based on the synchronization detection signal LOCK.

Next, the write circuit 110 writes the signal data DTw in the FIFO buffer 10 according to the write clock signal CLKw (step St7). More specifically, the write circuit 110 writes a predetermined amount of the signal data DTw in the write address ADw generated by the write address generation circuit 111. As described above, the stuff data is excluded from the signal data DTw to be written.

Next, the read reset circuit 14 determines whether the reset (RST) state of the read block (BLK) 12 is already released (step St8). When the reset state is already released (Yes/step St8), the process of step St11 is executed as described later.

When the reset state is not released yet (No/step St8), the read reset circuit 14 compares the write address ADw in which the signal data DTw has been written with the reference address ADs (step St9). In the above operation, since the reference address ADs is already corrected with the correction value ΔAD, the reference address ADs is the sum of its initial value ADi and the correction value ΔAD.

ADw≧ADs=ADi+ΔAD (1)

More specifically, the read reset circuit 14 determines whether the above inequality (1) holds. Here, the initial value ADi may be the address corresponding to the position of the half of the storage capacity in the address space of the FIFO buffer 10. In addition, the correction value ΔAD is determined by the address correction circuit 17 based on the phase difference Ep.

When the inequality (1) does not hold (No/step St9), the write circuit 110 writes the signal data DTw in the FIFO buffer 10 (step St7). Thus, till the reset state of the read block 12 is released, only the writing in the FIFO buffer 10 continues.

When the inequality (1) holds (Yes/step St9), the read reset circuit 14 releases the reset state of the read block 12 (step St10). More specifically, the read reset circuit 14 varies the voltage level of the read reset signal RSTr from the low level to the high level. As described above, the read reset circuit 14 controls the timing for starting the reading of the signal data DTr from the FIFO buffer 10 based on the result of comparison between the write address ADw and the reference address ADs.

Next, the read circuit 120 reads the signal data DTr from the FIFO buffer 10 according to the read clock signal CLKr (step St11). More specifically, the read circuit 120 reads the signal data DTr from the read address ADr generated by the read address generation circuit 121. The signal data DTr that has been read is output to a processing circuit subsequent to the data rate conversion circuit in the demapping processing unit 93.

Thereafter, when the process is ended because of the error of the transmission device 9b, device reset, or reboot (Yes/step St12), the data rate conversion circuit 93a ends the operation. When the process is not ended (No/step St12), the process of step St7 is executed again. In the above described manner, the data rate conversion circuit 93a operates.

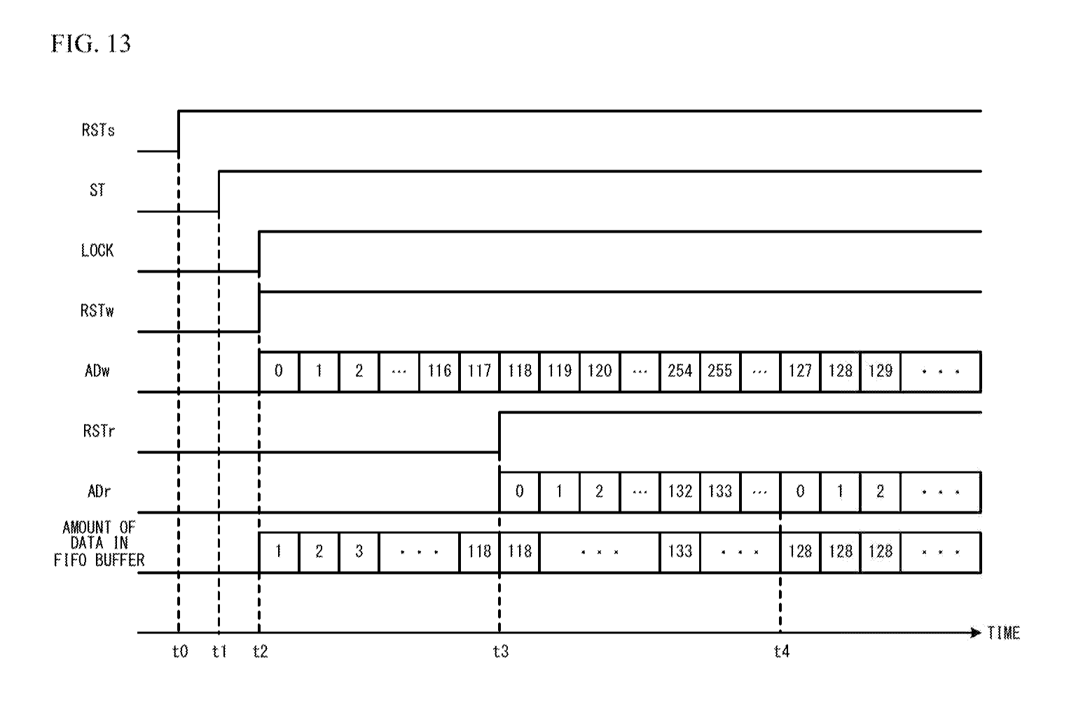

FIG. 13 is a timing diagram illustrating exemplary operations of the data rate conversion circuit 93a. In this example, it is assumed that the address space of the FIFO buffer 10 is composed of 256 storage areas, and the range of the write address ADw and the range of the read address ADr are 0 to 255. In addition, it is assumed that the initial value ADi of the reference address ADs is 128, which is the center of the range, and the correction value ΔAD is −10. That is, it is assumed that the reference address ADs is 118 (=128-10).

At time t0, the voltage level of the device reset signal RSTs varies from the low level to the high level. This causes the timer circuit 154 to start the timer in the PLL circuit 15. At time t1, the timer circuit 154 outputs the operation instruction signal ST in response to the expiration of the timer. In the above operation, the voltage level of the operation instruction signal ST varies from the low level to the high level. This causes the synchronization detection circuit 155 to start the detection of the phase synchronization.

At time t2, the synchronization detection circuit 155 determines the establishment of the phase synchronization, and outputs the synchronization detection signal LOCK. In the above operation, the voltage level of the synchronization detection signal LOCK varies from the low level to the high level. In addition to the output of the synchronization detection signal LOCK, the write reset signal RSTw is also output, releasing the reset state of the write block 11.

This causes the write circuit 110 and the write address generation circuit 111 to start operating. The write address ADw is incremented from 0 by a predetermined value according to the write clock signal CLKw. The amount of data in the FIFO buffer 10 increases from 1 by a predetermined value according to the write clock signal CLKw.

At time t3, when the write address ADw reaches 118, the read reset signal RSTr is output, releasing the reset state of the read block 12.

This causes the read circuit 120 and the read address generation circuit 121 to start operating. The read address ADr is incremented from 0 by a predetermined value according to the read clock signal CLKr. In addition, the amount of data in the FIFO buffer 10 when the reading from the FIFO buffer 10 is started is 118 (=256÷2). However, the amount of data in the FIFO buffer 10 then fluctuates in accordance with the fluctuation of the read clock signal CLKr during the transient state of the PLL circuit 15.

At time t4, when the fluctuation of the read clock signal CLKr converges, the amount of data in the FIFO buffer 10 becomes 128 that is half of the storage capacity. Thereafter, since the amount of data in the FIFO buffer 10 fluctuates around 128, the margins for the overflow and underflow of the FIFO buffer 10 are sufficiently secured.

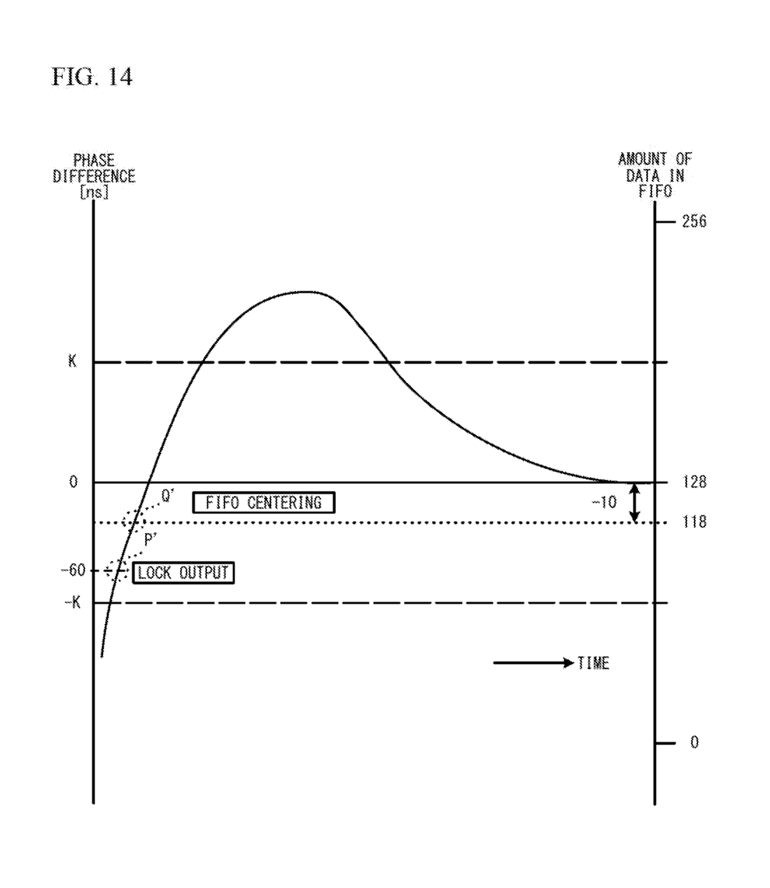

FIG. 14 illustrates an exemplary relation between the variation in phase difference Ep in the PLL circuit 15 of the embodiment and the amount of data in the FIFO buffer 10. More specifically, FIG. 14 illustrates the variation in the amount of data due to the fluctuation of the read clock signal CLKr during the time period from time t3 to t4 illustrated in FIG. 13. Assume that the data rate of the signal data DTr read from the FIFO buffer 10 is, for example, 166 (Mbps).

The PLL circuit 15 determines the establishment of the phase synchronization and outputs the synchronization detection signal LOCK when the phase difference Ep is 60 (ns) as indicated by referential mark P′. In the address correction circuit 17, the correction value generation circuit 170 retrieves the correction value ΔAD=−10 from the correction value table 171 based on the phase difference Ep=60 (ns) input from the PLL circuit 15. Through this process, the reference address ADs is corrected to 118 (=128-10).

Thereafter, the writing of the signal data DTw in the FIFO buffer 10 starts, and when the write address ADw reaches the reference address ADs=118, the FIFO centering is conducted as indicated by referential mark Q′. In the above operation, since the reference address ADs is the value corrected with the correction value ΔAD that takes into account the deviation at the time of the convergence of the fluctuation of the read clock signal CLKr, the amount of data becomes 118, which is less than 128 corresponding to half of the storage capacity by 10, taking into account the deviation at the time of the convergence of the fluctuation of the read clock signal CLKr.

Thus, when the fluctuation of the read clock signal CLKr converges, the amount of data becomes 128, which is equal to the initial value ADi of the reference address ADs. As described above, in this example, after the writing of the signal data DTw in the FIFO buffer 10 starts, the FIFO centering is conducted before the amount of data becomes 128, which is half of the storage capacity of the FIFO buffer 10. Thus, the amount of data at the time of the convergence of the fluctuation of the read clock signal CLKr is made to be 128.

Therefore, since the amount of data fluctuates around 128 as indicated by referential mark G6 in FIG. 8, the margins for the overflow and underflow of the FIFO buffer 10 are sufficiently secured. Hence, the present embodiment eliminates the need to increase the storage capacity of the FIFO buffer 10, and thereby reduces the increase in communication latency and improves the communication performance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A data processing device comprising:
a buffer from which data is read in an order that the data is written;
a write circuit configured to write data in the buffer according to a write clock signal;
a read circuit configured to read data from the buffer according to a read clock signal,
a PLL circuit configured to conduct a phase synchronization processing of the read clock signal based on a phase difference between the write clock signal and the read clock signal, and to output a notification signal when the phase difference becomes within a predetermined range;
a write control circuit configured to control a timing at which the write circuit starts writing based on the notification signal;
a read control circuit configured to compare an address in which data is written by the write circuit and a reference address, and to control a timing at which the read circuit starts reading based on a comparison result; and
a correction circuit configured to correct the reference address with a correction value corresponding to the phase difference that is obtained when the notification signal has been output.

2. The data processing device according to claim 1, wherein:
the correction circuit includes a table in which a relation between the phase difference and the correction value is registered; and
the correction circuit obtains from the table the correction value corresponding to the phase difference that is obtained when the notification signal has been output.

3. The data processing device according to claim 1, wherein the write circuit extracts data to be written in the buffer from signal data included in a frame signal.

4. The data processing device according to claim 1, wherein the reference address before corrected by the correction circuit is an address corresponding to a position of a half of a storage capacity in an address space of the buffer.

5. A data processing method that writes data in a buffer according to a write clock signal and reads data from the buffer according to a read clock signal in an order that the data is written, the data processing method comprising:
conducting a phase synchronization processing of the read clock signal based on a phase difference between the write clock signal and the read clock signal;
outputting a notification signal when the phase difference becomes within a predetermined range;
controlling a timing for starting writing of data in the buffer based on the notification signal;
comparing an address of the buffer in which data is written and a reference address;
controlling a timing for starting reading of data from the buffer based on a result of the comparing; and
correcting the reference address with a correction value corresponding to the phase difference that is obtained when the notification signal has been output.

6. The data processing method according to claim 5, further comprising:
obtaining from a table the correction value corresponding to the phase difference that is obtained the notification signal has been output, a relation between the phase difference and the correction value being registered in the table.

7. The data processing method according to claim 5, further comprising:
extracting data to be written in the buffer from a signal data included in a frame signal.

8. The data processing method according to claim 5, wherein
the reference address before corrected by the correcting is an address corresponding to a position of a half of a storage capacity in an address space of the buffer.
